(19) United States
(12) Patent Application Publication
(10) Pub. No.: US 2017/0085066 A1
(43) Pub. Date: Mar. 23, 2017

(54) System, Apparatus and Methods for a Fish Tape Guide

(71) Applicant: Clayton Buck, Moorseville, NC (US)

(72) Inventor: Clayton Buck, Moorseville, NC (US)

(21) Appl. No.: 15/273,319

(22) Filed: Sep. 22, 2016

Related U.S. Application Data
(60) Provisional application No. 62/221,988, filed on Sep. 22, 2015.

(51) Int. Cl. H02G 1/08; H02G 3/04

(52) U.S. Cl. CPC H02G 1/081; H02G 3/0437

(57) ABSTRACT

A fish tape guide is described which uses a spring and spherical bead system to guide the fish tape through dense conduits. The spring portion helps in giving the essential flexibility and the spherical bead helps in guiding in a desired direction through dense conduits. The spherical bead being connected to the end of the fish tape with a two ended tag. Further when the guide is attached to the fish tape it can be used to hook on and pull an external wire in a desired direction.

### CROSS REFERENCES TO RELATED APPLICATIONS

This application claims the benefit of U.S. Provisional Patent Application No. 62/221,988, filed Sep. 22, 2015, entitled as “Apparatus and Methods for a Fish Tape Guide”, which is incorporated herein by reference in its entirety.

### FIELD

The inventive subject matter relates to methods and apparatus for a fish tape guide in general, specifically a fish tape guide which uses a spring portion and spherical bead system to guide the fish tape.

### BACKGROUND

A fish tape (also known as a draw wire or draw tape) is a tool used by electricians to route wires through walls and electrical conduit. Usually they are made of a narrow band of spring steel, by careful manipulation, the tape can be guided through confined spaces such as wall cavities. The goal is to push toward an area where guide string has been dropped inside the confined space and to pull it through, so the guide string can then be used to pull through various types of wires, such as phone wire, network cables or speaker wire.

Fish tapes are usually stored coiled on a plastic reel. Because of this, they have a natural curvature and it is this curvature that allows them to be guided. By manipulating the reel, the end of the tape can be directed slightly. The tape is rigid enough that it can then be pushed in the direction in which it is pointing. In this way it can be easily guided through an empty wall cavity. Thermal insulation, firestops, pipes, HVAC ducts, electrical conduits, and other obstructions make use of a fish tape more challenging. The “tape” can be made from many different materials including steel, fiberglass, and nylon. The tape usually has a special end ranging from a hook or loop to a specialized fastener device to allow the user to attach the tape to the guide string (or a very light cable) before pulling.

U.S. Pat. No. 3,549,127 to Niermann describes an electrician's fish tape reel assembly including an electrician's fish tape, a reel formed of a pair of annular sections.

U.S. Pat. No. 3,568,947 to Oprins describes an electrician's fish tape reel assembly including an electrician's fish tape, a reel formed of a pair of annular sections.

U.S. Pat. No. 400,958 to J. A. Seely describes a leading in apparatus for conduits which mainly consists of series of anti-friction pieces united by a flexible mechanical connection.

U.S. Pat. No. 3,329,803 to Elmore L. Sink describes describe a fish tape having an electrical heater connected to one end of a stiff but coil able, electrically conductive tape.

U.S. Pat. No. 3,528,644 to William J. Scott describes a fish tape reel with staggered tape engaging lips

U.S. Pat. No. 5,505,432 to Noonan describes a fish tape for installing electrical conductors in conduits with an anti-snagging device, which constitutes a spherical roller as the leading portion of the fish tape.

U.S. Pat. No. 6,361,021 to Brennan describes a power driven fish tape which includes a handle and spoon.

U.S. Pat. No. 2,509,100 to Jordan describes a flexible fish tape leader which mainly constitutes a coil compression spring surrounding a cable extending head and tail piece.

Generally, the fish tape leader is joined to the fish tape by using tedious high temperature welding procedures for the joining parts.

Accordingly, there exists a need for a fish tape guide with better guiding capabilities through dense conduits. Also needed is a fish tape guide which can be attached to a fish tape without welding of the joining parts.

### SUMMARY

The present inventive subject matter describes a fish tape guide for use with a fish tape. The fish tape guide being easily attachable and detachable to the fish tape.

In one of the embodiments a fish tape guide comprising of a spring and spherical bead assembly is described. The spring helps in giving the essential flexibility and the spherical bead helps in guiding in a desired direction through dense conduits.

In another embodiment the fish tape guide spherical bead being connected to a fish tape through the eyelets at the terminal end of the fish tape with a two ended tag is described.

In yet another embodiment the steps involved in pulling in an external wire through a channel in a conduit is described.

It should be understood that the summary above is provided to introduce in simplified form a selection of examples that are further described in the detailed description. It is not meant to identify key or essential features of any claimed subject matter that may later claim priority to the present description. Furthermore, the scope of any such claimed subject matter would not be limited to implementations that solve any disadvantages noted above or contained herein.

### BRIEF DESCRIPTION OF THE DRAWINGS

Many aspects of the present invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 describes a first embodiment for a fish tape guide.

FIG. 2 illustrates a second embodiment showing a pulling/hooking of a wire with the fish tape guide described.

FIG. 3 illustrates the tight snapping of the pulled wire.

FIG. 4 illustrates the guiding of the fish tape guide in “L” shaped channels.

FIG. 5 Illustrates method steps.

### REFERENCE CHARACTERS

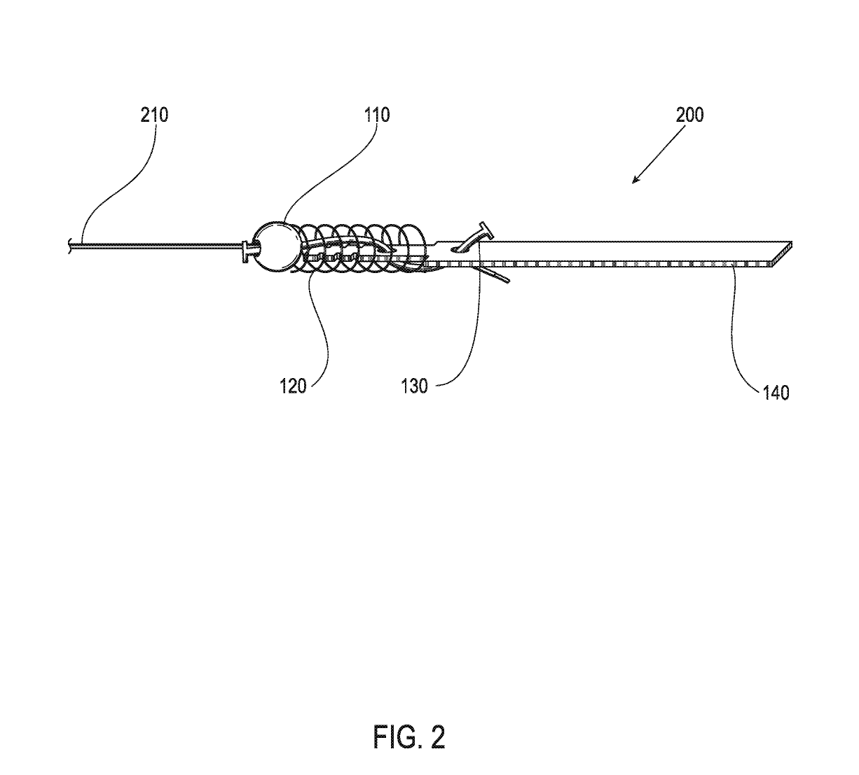

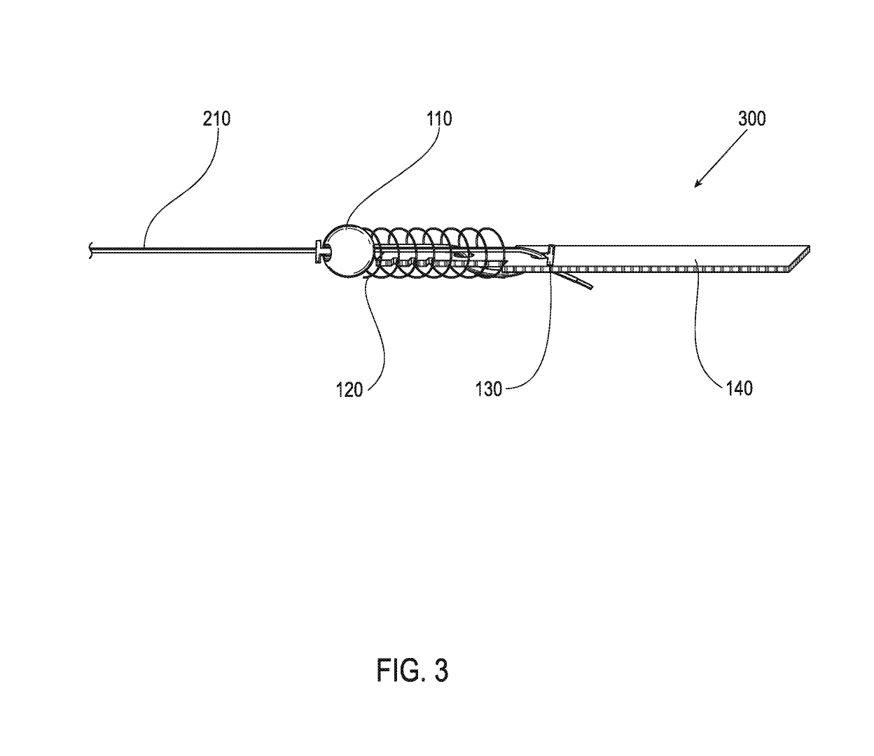

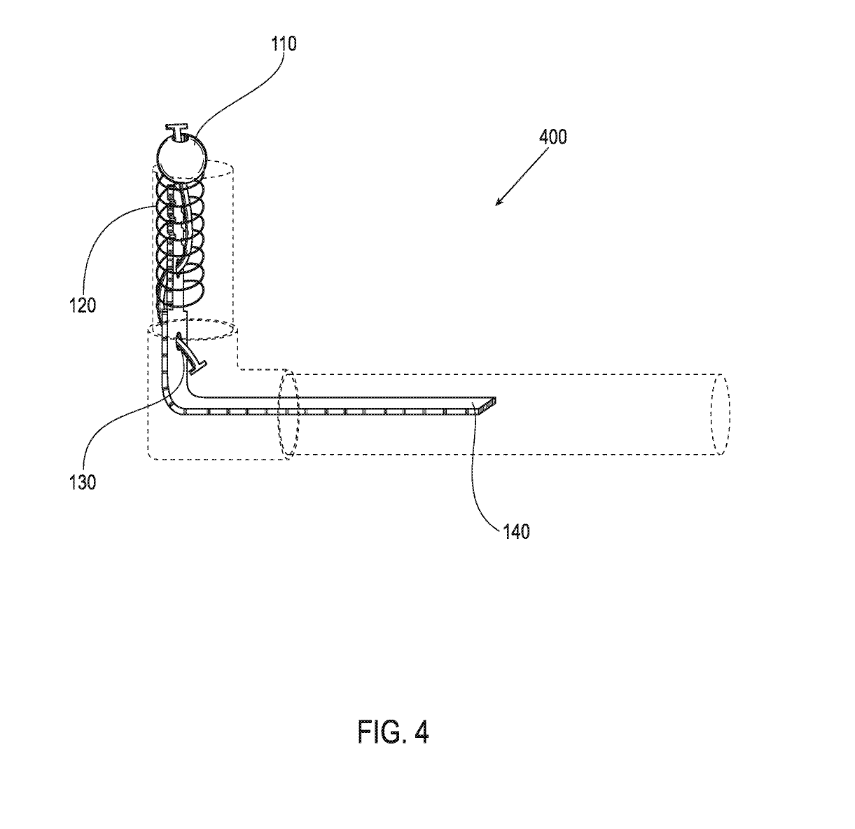

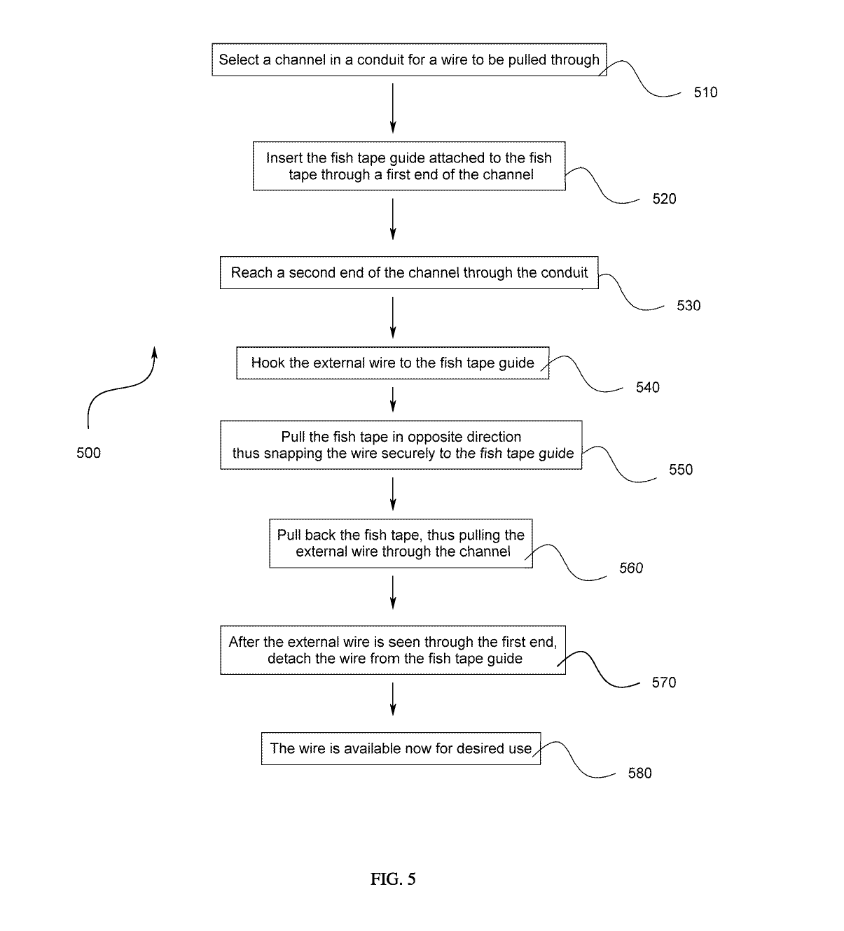

100: Fish tape guide assembly
110: Spherical bead
120: Spring
130: Two ended tag
140: Fish tape
150A and 150B: Eyelets
200: Illustrates FIG. 2
210: External wire
300: Illustrates FIG. 3
400: Illustrates FIG. 4
500: Illustrates FIG. 5
510-580: Method steps of a preferred embodiment

### DETAILED DESCRIPTION

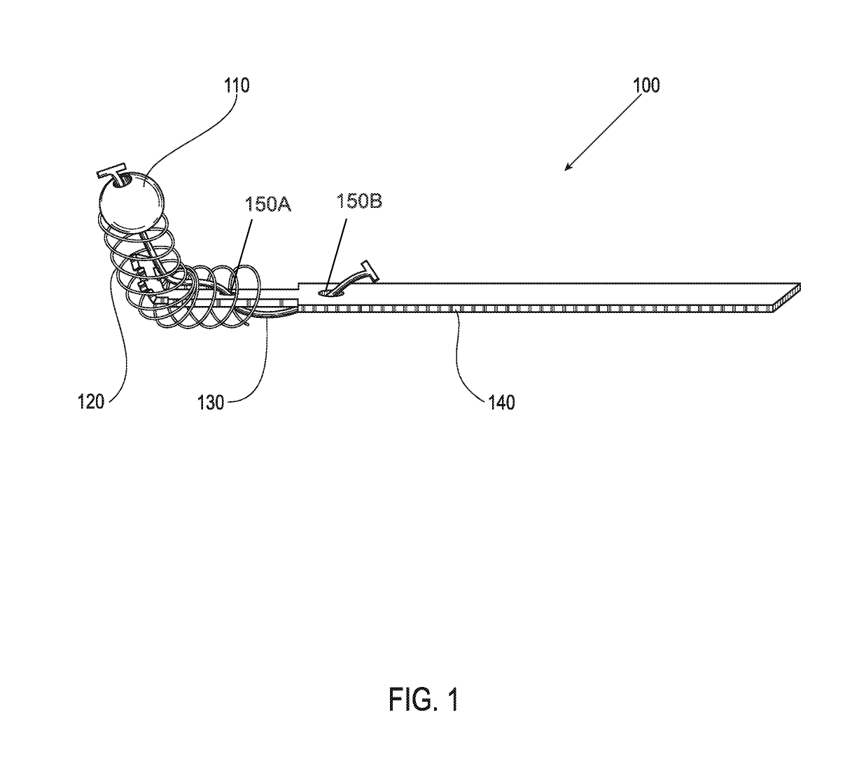

The embodiments in this disclosure, as illustrated in FIGS. 1 through 5 and described in the text below, may be adapted for use with fish tape of different sizes and made of different material characteristics, including, but not limited to, the description below.

An exemplary embodiment is as illustrated in FIG. 1, wherein a spherical bead-spring system 100 for use as a fish tape guide. A spherical bead 110 is appended on to a distal end of a two ended tag. The proximal end of the two ended tag 130 is buckled to the terminal end of the fish tape through the eyelets 150A and 150B. A spring portion 120 envelops the two ended tag 130 and the terminal end of the fish tape. As the fish tape is pushed through, the spherical bead helps guide it through a pipe or channel (not shown). The spring portion 120 provides the essential flexibility without putting too much stress on the fish tape 140. The fish tape guide assembly illustrated in 100 does not require high temperature welding for assembly. The fish tape assembly does not have any rigid connections thus making way for a stress-free operational use of the fish tape assembly.

The spherical bead 110 can be made up of different material like steel, plastic or magnetic depending on application preferences. Further the spherical bead can be made of different bore diameters to make way for different sizes of a two ended tags. Also the spherical bead can be made of solid or hollow structure.

The fish tape 140 can be made of steel or nylon tapes based on application preferences.

The spring portion 120 can be made of steel, plastic or magnetic depending on application preferences. Further the spring portion can be of different lengths and having varied number of coils based on application preferences. An open ended spring is preferred for its better springing action and flexibility than a close ended spring for the purposes of the above described inventive subject matter.

The fish tape guide can be attached to the fish tape by varied means of attachment like a screw on, press on, hook on, snapped on or a magnetic attachment technique or the like. The advantage of all these type of attachments being that they can be easily detached and are customizable based on application preferences.

It should be appreciated by those of ordinary skill that the specific structural and material configurations of the spherical bead, fish tape and the spring portion are exemplary only. Other design configurations may be used that generally fall within the spirit and scope of the present disclosure.

In a preferred embodiment with reference to the fish tape guide assembly described in FIG. 1, the spherical bead has a diameter ranging between 0.7 to 0.8 inches and the bore diameter ranging between 0.12 to 0.13 inches, the two ended tag has a diameter of 0.03 to 0.04 inches and an open ended spring portion with 28 coils.

Now referring to FIG. 2, 200 illustrates the initial hooking on of an external wire to the fish tape guide assembly 100 through the spherical bead portion 110 and the spring portion and the eyelet 150B.

Referring to FIG. 3, 300 illustrates the snapped tight position after the fish tape is pulled in opposite direction. When the fish tape guide is hooked on to an external wire the fish tape guide helps in securing the wire tight by pulling the fish tape in opposite direction. The harder it is pulled the tighter it gets. The external wire can be easily pulled through a dense conduit in a desired direction and the external wire can be easily unhooked off from the fish tape guide for further use.

Now referring to FIG. 4, 400 refers to a scenario where the fish tape guide is pushed through an “L” shaped channel. The spring portion of the fish tape guide helps if flexibly pushing it through the “L” shaped tube.

Now referring to FIG. 5, 500 describes the method steps involved in pulling an external wire through a dense conduit. A preferred channel through a conduit is selected for the external wire to be pulled through 510. The fish tape guide attached to the fish tape is inserted at the first end of the channel 520. The fish tape is guided through the channel via the fish tape guide to reach a second end of the channel 530. The external wire is hooked fish tape guide at the second end 540. The fish tape is pulled in opposite direction thus snapping the wire securely to the fish tape guide 550. The fish tape is pulled back, thus pulling the external wire through the conduit. 560. After the external wire is seen through the first end, the fish tape is detached from the external wire 570. The external wire is now available for desired use at the first end 580.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

1. A fish tape guide, the fish tape guide comprising:
a two ended tag, the two ended tag having a distal end and a proximal end;
a spherical bead appended to the distal end of the two ended tag;
a spring portion enveloping a portion of the two ended tag between the distal end and proximal end; and
the fish tape guide adapted to be attachable to a fish tape.

2. The fish tape guide of claim 1 wherein the fish tape guide is buckled on to a terminal end of a fish tape.

3. The fish tape guide of claim 1 wherein the fish tape guide is screwed on to a terminal end of a fish tape.

4. The fish tape guide of claim 1 wherein the fish tape guide is snapped on to a terminal end of a fish tape.

5. The fish tape guide of claim 1 wherein the fish tape guide is pressed on to a terminal end of a fish tape.

6. The fish tape guide of claim 1 wherein the fish tape guide is magnetically connected on to a terminal end of a fish tape.

7. The fish tape guide as described in claim 1 further the spherical bead made of steel material.

8. The fish tape guide as described in claim 1 further the spherical bead made of plastic material.

9. The fish tape guide as described in claim 1 further the spherical bead made of magnetic material.

10. The fish tape guide as described in claim 1 further the fish tape made of steel material.

11. The fish tape guide as described in claim 1 further the fish tape made of nylon material.

12. A method for a fish tape guide comprising:
guiding a fish tape attached to a fish tape guide through a conduit;
hooking an external wire to the fish tape guide through a beaded spherical portion, two ended tag and spring portion;
snapping the external wire tightly by the fish tape guide and the fish tape;
pulling the external wire via the fish tape guide and fish tape through the conduit.

13. The method as described in claim 12, wherein the conduit has “L” shaped channels as pathways for the external wire.
